(19) United States
(12) Patent Application Publication
(10) Pub. No.: US 2012/0043065 A1
(43) Pub. Date: Feb. 23, 2012

(54) Method for Producing a Cooling Element for Pyrometallurgical Reactor and the Cooling Element

(75) Inventors: Pasi Ranne, Naakila (FI); Tuomas Renfors, Bjorneborg (FI); Ari Lehtola, Ahlainen (FI)

(73) Assignee: Luvata Espoo Oy, Espoo (FI)

(21) Appl. No.: 13/318,647

(22) PCT Filed: May 6, 2009
(86) PCT No.: PCT/FI2009/050366

§ 371 Date: Nov. 3, 2011

(51) Int. Cl. F28F 1/00; B23P 15/26

(52) U.S. Cl. 165/172; 29/890.053

(57) ABSTRACT

Cooling element (2) for pyrometallurgical reactors and method of manufacturing the element, wherein at least one cooling channel (1) having two ends is provided first. Each end of the cooling channel (1) has connection means (17) for cooling medium and at least one cooling channel (1) is connected connecting means to a wall of pyrometallurgical reactor. Further, at least one tube having an outer cross section and inner cross section is formed and the tube bent to an open loop to form at least one cooling channel, the ends of which being joinable to the means (3) for connecting the cooling channel (1) to a wall of pyrometallurgical reactor.

This invention relates to cooling elements of pyrometallurgical reactors such as blast furnaces and similar used for producing and refining metals or metal alloys. The largest field of use of such reactors is manufacture of steel.

Pyrometallurgical reactors comprise a reactor vessel, usually made of steel, cooling elements arranged inside the reactor vessel and against its wall and a refractory layer forming the inside surface of the reactor. The refractory layer is made of bricks or flowing refractory material that is spread on the surface of the cooling elements, or both. If flowing refractory material is used, the cooling elements are embedded within carbon material and silicon carbide can be used for further protection. When bricks are used, cooling elements can be flat and wide plates that face inside the furnace. These cooling elements have crosswise grooves for attaching the bricks to the elements. When the cooling elements are attached to the reactor vessel, the grooves run horizontally as well as the brick layers. In addition of above mentioned elements, the reactor vessel includes passages and means for introducing metal materials, fuel, air, oxygen or shield gases and additives to the reactor, all according to the process for which the reactor is used.

The refractory layer of reactors in pyrometallurgical processes is protected by water-cooled cooling elements so that, as a result of cooling, the heat coming to the refractory surface is transferred via the cooling element to water, whereby the wear of the lining is significantly reduced compared with a reactor which is not cooled. Reduced wear is caused by the effect of cooling, which brings about forming of so called autogenic lining, which fixes to the surface of a heat resistant lining. This lining is formed from slag and other substances precipitated from the molten phases.

Conventionally cooling elements are manufactured in two ways: primarily, elements can be manufactured by sand casting, where cooling pipes made of a highly thermally conductive material such as copper are set in a sand-formed mould, and are cooled with air or water during the casting around the pipes. The element cast around the pipes is also of highly thermally conductive material, preferably copper. This kind of manufacturing method is described in e. g. GB patent no. 1386645. One problem with this method is the uneven attachment of the piping acting as cooling channel to the cast material surrounding it. Because of this some of the pipes may be completely free of the element cast around it and part of the pipe may be completely melted and thus damaged. If no metallic bond is formed between the cooling pipe and the rest of the cast element around it, heat transfer will not be efficient. Again, if the piping melts completely, that will prevent the flow of cooling water. The casting properties of the cast material can be improved, for example, by mixing phosphorus with the copper to improve the metallic bond formed between the piping and the cast material, but in that case, the heat transfer properties (thermal conductivity) of the copper are significantly weakened by even a small addition. One advantage of this method worth mentioning is the comparatively low manufacturing cost and independence from dimensions.

Another method of manufacture is used, whereby glass tubing in the shape of a channel is set into the cooling element mould. The glass is broken after casting to form a channel inside the element. When sand casting is used, every piece has to be proven by X-ray photography to guarantee tightness against gas or liquid leaks. This is mandatory since if cooling water escapes to the furnace, damages may be devastating. However, 100% quality control and x-ray photography increase costs considerably

U.S. Pat. No. 4,382,585 describes another, much used method of manufacturing cooling elements, according to which the element is manufactured for example from rolled copper plate by machining the necessary channels into it. The advantage of an element manufactured this way, is its dense, strong structure and good heat transfer from the element to a cooling medium such as water. Disadvantages are limited size because of dimensional limitations and high cost.

A well-known method in the prior art has been to manufacture a cooling element for a pyrometallurgical reactor by casting a hollow profile as continuous casting i. e. slip casting through a die. Lengthwise holes can be made to the element by mandrels. The element is manufactured of a highly thermally conductive metal such as copper. The advantage of this method is a dense cast structure, good surface quality and the cast cooling channel gives good heat transfer from the element to the cooling medium, so that no effects impeding heat transfer occur, rather the heat coming from the reactor to the cooling element is transferred without any excess heat transfer resistance directly to the surface of the channel and onwards to the cooling water. The cross-section of the cooling channel is generally round or oval and the mandrel has a smooth surface. This type of cooling channel is mentioned in U.S. Pat. No. 5,772,955.

In order to improve the heat transfer capability of a cooling element it is however preferable to increase the heat transfer surface area of the element. This can be done by increasing the wall surface area of the flow channel without enlarging the diameter or adding length. The wall surface area of the cooling element flow channel is increased by forming grooves in the channel wall during casting or by machining grooves or threads in the channel after casting so that the cross-section of the channel remains essentially round or oval. As a result, with the same amount of heat, a smaller difference in temperature is needed between the water and the flow channel wall and an even lower cooling element temperature. This method is described in WO/2000/037870.

The purpose of this invention is to produce a new method for making cooling elements for pyrometallurgical reactors and new cooling element made according to the method.

Further, the purpose of the invention is to create a cooling element that is more cost effective to produce.

Further, purpose of one embodiment of the invention is to produce a cooling element that uses less material compared to known elements.

Purpose of one embodiment of the invention is to diminish machining required for producing the cooling element.

The invention is based in that at least one cooling channel of the cooling element is formed of tube material that is bent on an open loop and each end of the tube is equipped with connections for cooling medium and means for attaching it to a wall of pyrometallurgical reactor.

According to one preferred embodiment of the invention, the cooling element comprises one cooling channel.

According to one preferred embodiment of the invention the cooling element comprises two cooling channels arranged parallel so that one of the channels forms outer channel and second of the channels is nested within the loop of the outer channel.

According to one preferred embodiment of the invention that the ends of at least one cooling channel are bound together by a steel tie.

More specifically, the cooling element and method for its manufacture according to the invention is characterized by what is presented in the independent claims.

The embodiments of the invention provide essential benefits.

The element is much easier to manufacture and no casting or excessive machining is needed. Since the element is formed of a tube, considerable savings in materials is achieved. In a sans casted or machined element, the element forms a plate, wherein the spaces between the cooling channels are filled with the same material of which the cooling channels are formed. In an element according to the invention, expensive material that forms the walls of the cooling channels is needed only to produce strong enough walls for the cooling channel. The space left inside the loop of the cooling channel or channels can be filled with same graphite material that is used for lining the furnace. Now the amount of material needed can be reduced to half in comparison to cast or machined cooling elements for single loop cooling elements and savings are considerable for double looped elements also. Since cooling elements are usually made of copper that is rather expensive, any saving in the material costs gives competitive edge.

The cooling element according to the invention can be manufactured very fast, where by elements can be made on order on a short delivery time. The delivery time can be reduced in half This reduces need of stored elements both at manufacturer and the user and makes it possible to react fast on incoming orders. Since the cooling element is made of tube material that is gas tight itself, quality control is easy and only sample test are needed to verify that the quality meets the set standards. The quality is higher and varies little since the manufacturing process more predictable and uses methods that are easily performed compared to, for example sand casting.

The invention is now described in more detail on basis of following examples and appended drawings.

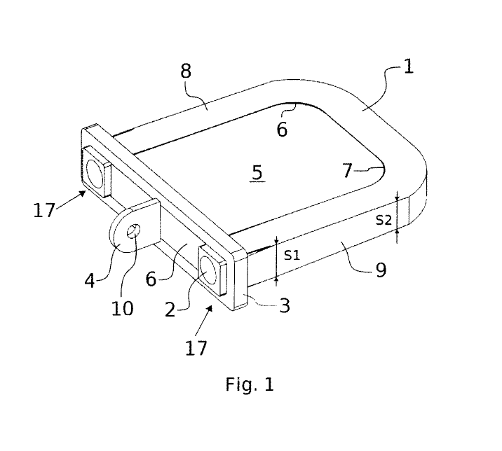

FIG. 1 shows one embodiment of a cooling element according to the invention.

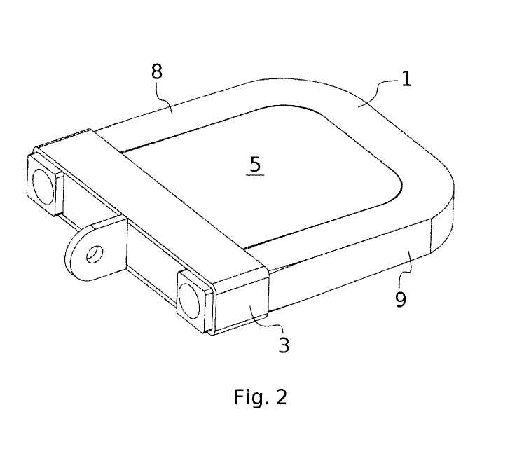

FIG. 2 shows one alternative embodiment of the invention.

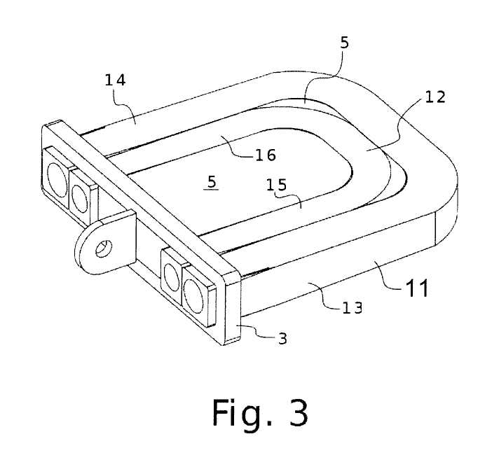

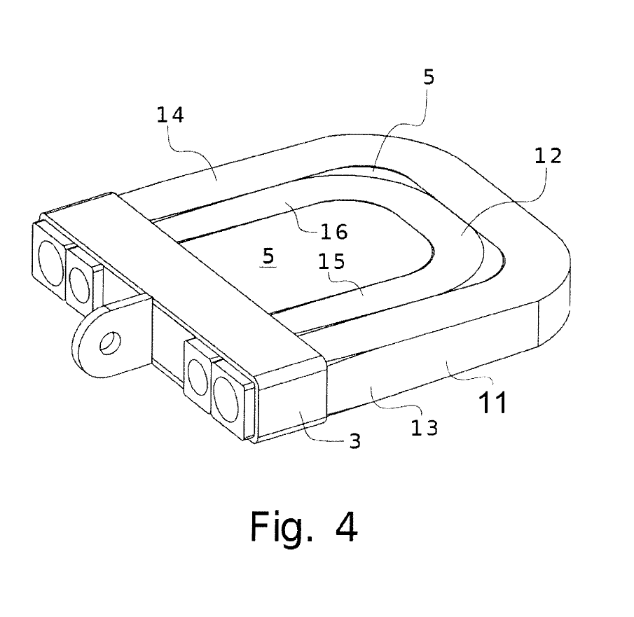

FIGS. 3 and 4 show second and third alternative embodiments of the invention.

In the following, for simplicity, a furnace is used as example of a pyrometallurgic reactor.

This invention concerns cooling elements that are inserted inside a furnace through a slot in the wall thereof. Such elements comprise plate-like body, usually made of copper, at least one cooling channel formed within the plate and means for attaching the cooling element to the wall of the furnace. The end of the cooling element opposite to the attaching means points towards the center of the furnace. This end or tip extends at the surface of the lining material and forms the primary heat transfer surface. The cooling element may extend somewhat inside the furnace from the lining surface, but should be covered with lining material in order to protect the copper material for erosion and wear. An autogenic lining formed on the inner surface of the furnace further protects the cooling elements.

The embodiment shown in FIG. 1 has a one cooling channel 1 that is made of a tube that has a rectangular outer cross section and circular inner cross section. The tube has been bent to a U-shaped open loop having two curved about 90° bends. The legs 8, 9 of the loop have same length.

The ends of the legs are attached to a steel tie 3. The steel tie 3 can be joined or attached to the cooling channel 1 by any means that provide gas tight seam. The preferred joining method is welding, but other methods like form pressing, forging, soldering or even threaded attachments can be used. The tie 3 can be ring that has an open center like in FIG. 1 or it can be a plate that has openings for the legs 8, 9 of the cooling channel. The area inside the loop of the cooling channel 1 is filled with graphite 5, which is also used for filling the space inside the tie 3, if a ring formed tie is used. This area has also be sealed gas tight to prevent any leaks from the blast furnace or any other pyrometallurgic reactor in which the cooling elements are used. The filling of the center can be done either during manufacture of the cooling element or during installation. The filling 5 may be graphite or any suitable substance that is used for forming the inner lining of a reactor vessel or furnace, provided that it is not heat sealing. Graphite or other filling replaces copper material of previously known cooler elements. Since it is light, conducts heat well and is relatively cheap, this feature saves material, provides lighter weight and better or at least as high thermal conductivity.

The tie 4 has a handle provided with a hole attached, for example by welding, at its middle. The handle can be used for supporting the cooling element during assembly and transport as well as for drawing the element out from the wall of the furnace.

When the cooling element is mounted on a furnace, the bottom part of the U-shaped loop is first pushed through a hole in the furnace wall. In order to aid installation through a hole, the thickness of the cooling element 1 is bigger on the side of the tie 3 (s₁) than at the bottom of the loop (s₂). The loop is also wider at the side of the tie 3 than at the bottom of the loop. Thus, a wedge shape is formed in two directions making the installation of the cooling element easier. This feature is not necessary for operation of the element but probably highly appreciated by clients for easier and faster mounting. Forming the wedge shape in crosswise direction (s) is easy to make by machining.

The cooling element is attached on the wall of the furnace by welding. There is basically two ways to do that when ties 3 described in this application is used. The tie 3 may form a collar over the hole in the furnace wall and the tie is welded over the edges of the hole, or the outer surface of the tie may be dimensioned to fit into the hole and the edges of the hole are welded around the tie 3. The tie shown in FIG. 1 (also in FIG. 3) is suitable for both applications, but is preferably used for the first option. Welding over the wall surface provides very accurate installation in relation to the wall but no possibility to adjust the position of the cooling element in depth direction.

This cooling element and methods for mounting may be used for making cooling system for new furnace, for replacing and restoring whole cooling system or repairs. It is suitable for replacing similar types of cooling elements, for adding cooling capacity at discovered hot spots or replacing damaged plate coolers.

The cooling channel 1 can be made several ways. One preferred method is to use continuously cast profile that has desired outer cross section as well as inner cross section. The cross sections as such are not limited by the invention and can be made to meet customer preferences and requirements. It can be even contemplated that the inner surface of the profile has ribs or other extension for increasing the rate of heat transfer. These ribs may, however, cause difficulties in bending the profile. A continuously cast profile is inherently gas tight and has good material properties that do not vary. Therefore it is good material for cooling channels and requires no check for leaks. In order to make a cooling channel 1, the cast profile of desired form is cut into length and bent to form an open loop of desired form. The U-shape shown above is suitable for replacing existing cooling elements. If a wedge form is desired, the channel has to be machined accordingly. In some cases rolling or pressing might be contemplated to make the wedge form. On the crosswise direction the wedge form is easily formed by controlling the degree of the bends 6, 7. The bending of the profile can be performed cold or hot.

When the cooling channel has been bent, it is joined with the tie 3 and the inside of the cooling channel loop is filled with graphite or other suitable filling material, if so is desired.

The cooling channel must be able to be joined in a cooling medium circulation. This can be provided by machining or forming couplings of desired kind at the ends of the cooling channel. This can be done either before bending or any stage after it. The coupling used can be threaded joint, fast coupling, any kind of tube coupling or a welded seam, at the simplest. The means for coupling a depicted by reference numeral 17. The ends of the channel 1 may herein represent a joint to be welded, for example.

Instead of continuously cast profile, a profile made by extruded profile or a profile wherein the hole is made by drilling. A problem related to drilling is that a great amount of material has to be removed. However, this material can be easily recycled for new prefabricates. On the other hand, there is plentiful blank materials that can be used for making such drilled profiles, for example they can be made by cutting from a wider continuously cast or otherwise manufactured blank.

In the embodiment in FIG. 2 the tie 3 connecting the legs 8, 9 of the cooling channel 1 are joined with a different type of a tie 3. This tie is wider than the tie in FIG. 1 and also thinner. This type of tie is preferred if mounted in the hole in the wall of a furnace. The width of the tie 3 makes it possible to adjust the position where the joining weld is done. Now the weld can be done anywhere on the width of the tie 3, thus providing adjustment of the seating depth of the cooling element.

The cooling effect of above described elements can be increased by using two cooling channels as shown in FIGS. 3 and 4. The outer channel 11 is formed and mounted on a tie 3 as described above. The inner channel 12 is formed in a similar way, but it is bent so that it can fit inside the outer channel 11 between the legs of the outer channel 11. In here the legs 15, 16 of the inner (second) channel 12 and the bends are dimensioned so that the outer surface of the legs 15, 16 of the inner channel 12 and the curve of the U-shape are in contact with the corresponding inner surfaces of the outer channel. At the bends there are some free spaces that can be filled with filler material. The channels 11, 12 may be arranged to contact each other as shown herein or they may be arranged free from each other. The best arrangement depends on which way a higher cooling effect is achieved, which further depends on what kind of filler material is used. The channels may contact in one or more points, be arranged to contact over the whole length or arranged so that the inner channel does not contact the outer channel. The embodiment of FIG. 3 uses a tie of FIG. 1 and embodiment is FIG. 4 tie of FIG. 2.

The cooling elements are dimensioned according to the cooling effect desired, which defines the volume rate of cooling water (or other medium in rare cases), which further defines how large the cross sections of the cooling channels have to be. Using two cooling channels increases cooling effect, but using three or more channels is not preferred, since increase in cooling effect is small compared to increased consumption of material. It is preferable to use more cooling elements instead. As an example, typical dimensions of a cooling element according to the invention might be 500×500 mm, the thickness of the wall of the outer cooling element facing the furnace being about 25 mm.

In the above, a U-shaped form of cooling channels has been used to describe the invention. The invention is not limited to any particular shape. The only limit is that what kind of shapes the profile that is used can be bent. Of course, manufacturers of blast furnaces and other kind of pyrometallurical reactors have their own cooling system designs and the shape and size of the cooling elements have to be designed accordingly.

The preferred material for cooling channel is copper and alloys thereof and for the tie steel chosen according to requirements of the environment.

Thus, while there have been shown and described and pointed out fundamental novel features of the invention as applied to a preferred embodiment thereof, it will be understood that various omissions and substitutions and changes in the form and details of the invention may be made by those skilled in the art without departing from the spirit of the invention. For example, it is expressly intended that all combinations of those elements and/or method steps which perform substantially the same results are within the scope of the invention. Substitutions of the elements from one described embodiment to another are also fully intended and contemplated. It is also to be understood that the drawings are not necessarily drawn to scale but they are merely conceptual in nature. It is the intention, therefore, to be limited only as indicated by the scope of the claims appended hereto.

1. Method for manufacturing a cooling element for pyrometallurgical reactors, the method comprising
forming at least one tube having an outer cross section and inner cross section,
bending the at least one tube to an open loop to form at least one cooling channel, the ends of which being joinable to the means for connecting the cooling channel (1) to a wall of pyrometallurgical reactor to form at least one cooling channel (1) having two ends,
providing each end of the cooling channel (1) with connection means (17) for cooling medium, and
joining at least one cooling channel (1) with means for connecting it to a wall of a pyrometallurgical reactor,
characterized by
forming the open loop of the cooling channel (1) to a wedge shape so that the thickness of the cooling element (1) is bigger on the side of the means for connecting to the wall of the pyrometallurgical reactor (s1) than at the bottom of the loop (s2).

2. Method according to claim 1 characterized by forming at least one tube by continuous casting.

3. Method according to claim 1 characterized by forming at least one tube by drilling a blank.

4. Method according to claim 1 characterized by forming at least one tube by extrusion.

5. Method according to claim 1, characterized in that the ends of at least one cooling channel (1) are bound together by a steel tie (3) that forms the means for connecting the cooling channel (1) to a wall of pyrometallurgical reactor.

6. Method according to claim 1, characterized in that the cooling channel is made of copper or an alloy thereof.

7. Cooling element for pyrometallurgical reactors, the element comprising:
at least one cooling channel (5) having two ends, the at least one cooling channel (1) being a tube that is bent to form an open loop,
connection means (17) for cooling medium at each end of the cooling channel (1), and
means for connecting the cooling channel (1) to a wall of pyrometallurgical reactor,
wherein the ends of the cooling channel (1) are attached to means for connecting the cooling channel (1) to a wall of pyrometallurgical reactor,
characterized in that the open loop of the cooling channel (1) has a wedge shape so that the thickness of the cooling element (1) is bigger on the side of the means for connecting to the wall of the pyrometallurgical reactor (s1) than at the bottom of the loop (s2).

8. Cooling element according to claim 7, characterized in that the cooling channel (1) is made of copper or an alloy thereof.

9. Cooling element according to claim 7, characterized in that at least one cooling channel is made of continuously cast copper.

10. Cooling element according to claim 7, characterized in that at least one cooling channel (1) is made of tube formed by drilling a blank.

11. Cooling element according to claim 7, characterized in that at least one cooling channel is made of extruded tube.

12. Cooling element according to claim 7, characterized in that at least one cooling channel has extension, for example ribs, within.

13. Cooling element according to claim 7, characterized in that the element comprises one cooling channel (1).

14. Cooling element according to claim 7, characterized in that the element comprises two cooling channels (11, 12) arranged parallel so that one of the channels forms outer channel (11) and second of the channels (12) is nested within the loop of the outer channel.

15. Cooling element according to claim 7, characterized in that the ends of at least one cooling channel (1) are bound together by a steel tie (3) that forms the means for connecting the cooling channel (1) to a wall of pyrometallurgical reactor.
